(19) United States
(12) Patent Application Publication
(10) Pub. No.: US 2007/0193611 A1
(43) Pub. Date: Aug. 23, 2007

(54) Illuminated convalescent walker

(76) Inventor: Linda Gallo, Cumberland, RI (US)

Correspondence Address: JAMES RAY & ASSOCIATES, 2640 PITCAIRN ROAD, MONROEVILLE, PA, 15146, US

(21) Appl. No.: 11/708,827

(22) Filed: Feb. 21, 2007

Related U.S. Application Data
(60) Provisional application No. 60/775,273, filed on Feb. 21, 2006.

(51) Int. Cl. A61H 3/00

(52) U.S. Cl. 135/66; 135/67

(57) ABSTRACT

An illuminated convalescent walker including a first inverted U-shaped tubular support member defining first and second leg members and a first handle member. There is a second inverted U-shaped tubular support member defining third and fourth leg members and a second handle member. At least one adjoining member is affixed to the first and third leg members for connecting the first and second inverted U-shaped tubular support members together. An illumination device is disposed within a predetermined portion of at least one of the leg members for providing light to increase visibility onto a walking path of a user. A power source is disposed within at least one of the first and second handle members and connected to the illumination device for providing energy thereto.

### CROSS REFERENCE TO RELATED APPLICATION

This application is closely related to and claims priority from U.S. Provisional Patent Application Ser. No. 60/775,273 filed on Feb. 21, 2006.

### FIELD OF THE INVENTION

The present invention relates, in general, to convalescent walkers used by the elderly and those recovering from sickness or weakness due to injury and, more particularly, the invention relates to a convalescent walker that illuminates for providing increased visibility onto the walking path of a user.

### BACKGROUND OF THE INVENTION

Convalescent walkers have been in use for many years prior to the conception and development of the present invention, as is generally well known in the prior art. These walkers help many people that require assistance to travel from one place to another, such as the elderly and disabled, who would otherwise be dependent on others to go anywhere.

However, stumbling and tripping is always a concern for those that need to use a walker, but especially at times when the user is in an area where the lighting is bad. For example, walking from the bedroom to the bathroom during the night, walking down a sidewalk in a dimly lit area after dark, etc., creates a dangerous situation.

### SUMMARY OF THE INVENTION

The present invention provides an illuminated convalescent walker for supplying increased visibility onto a walking path of a user. The illuminated convalescent walker includes a first inverted U-shaped tubular support member defining two substantially parallel, vertically disposed first and second leg members and a substantially horizontal first handle member. There is a second inverted U-shaped tubular support member defining two substantially parallel, vertically disposed third and fourth leg members and a substantially horizontal second handle member. At least one adjoining member is affixed to each of the first and third leg members for connecting the first inverted U-shaped tubular support member to such second inverted U-shaped tubular support member. An illumination means is disposed within a predetermined portion of at least one of the leg members for providing light to increase visibility onto such walking path of the user. A power source is disposed within at least one of the first and second handle members and connected to such illumination means for providing energy thereto.

### OBJECTS OF THE INVENTION

It is, therefore, one of the primary objects of the present invention to provide an illuminated convalescent walker that increases visibility in hard to see areas.

Another object of the present invention is to provide an illuminated convalescent walker that helps prevent a user from stumbling and falling due to normally unseen hazards along a walking path in dimly lit areas.

Still another object of the present invention is to provide an illuminated convalescent walker that offers various lighting options by simply pushing a control button.

Yet another object of the present invention is to provide an illuminated convalescent walker with legs having either removable resilient rubber grip bottoms, removable wheel bottoms capable of rotating 360°, or a combination of both by simply pushing a control button.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of an illuminated convalescent walker illustrating a presently preferred embodiment of the present invention.

FIG. 2 is a perspective view of an illuminated convalescent walker illustrating alternative embodiments of the present invention.

FIG. 3 is a perspective view of the flip down wheel member, illustrated in FIG. 1, either permanently or removably disposed on a lower distal end of at least one leg member of the illuminated convalescent walker.

FIG. 4 is a cross sectional view of the handle member, illustrated in FIGS. 1 and 2, having a power source disposed therein and a push button control switch disposed thereon for controlling various lighting options of the illuminated convalescent walker.

FIG. 5 is a cross sectional view of the spring loaded push pins, illustrated in FIGS. 1 and 2, used to install or remove the resilient rubber grip members and wheel members of the illuminated convalescent walker as well as adjust the length of the leg members.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

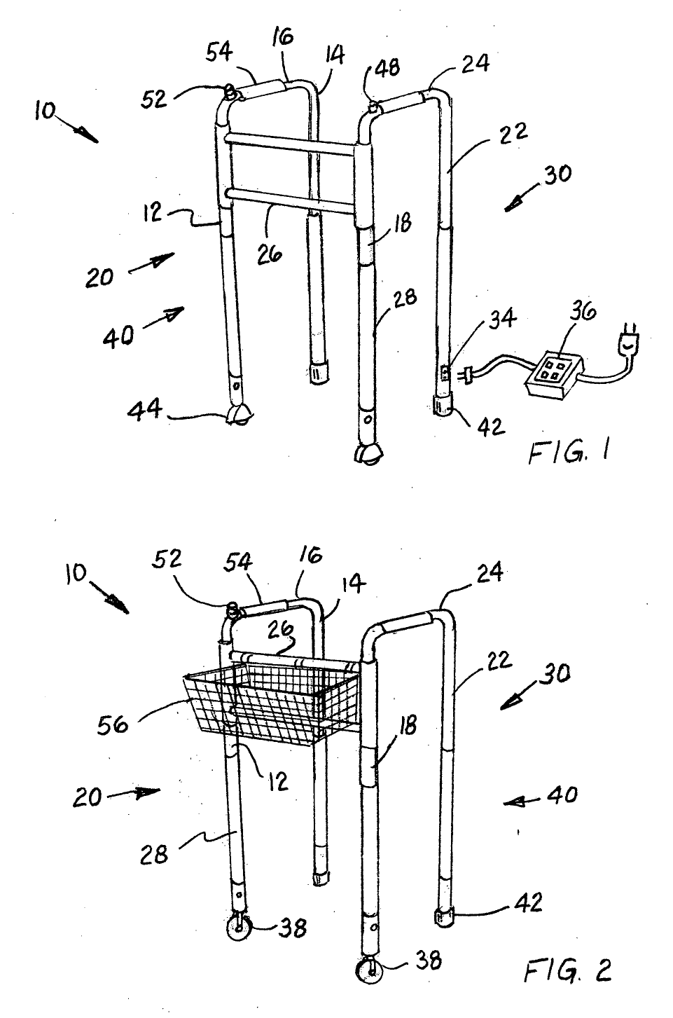

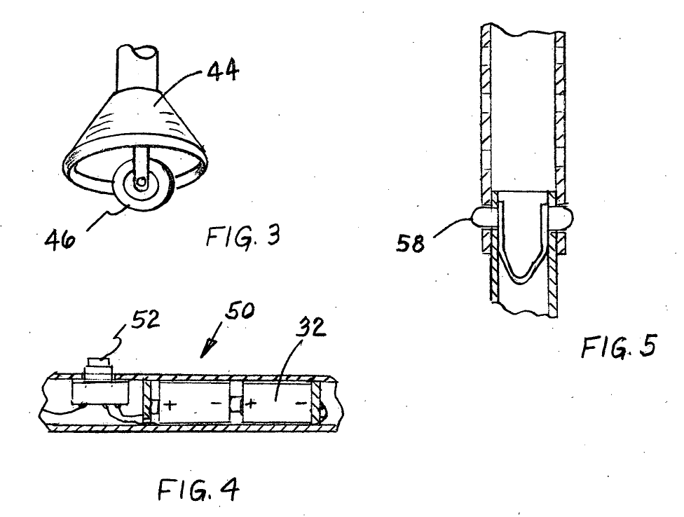

Reference is now made, more particularly, to drawing FIGS. 1 through 5. Illustrated therein is an illuminated convalescent walker, generally designated 10, for providing increased visibility onto a walking path of a user. The illuminated convalescent walker 10 includes a first inverted U-shaped tubular support member, generally designated 20, defining two substantially parallel, vertically disposed first 12 and second 14 leg members and a substantially horizontal first handle member 16.

There is a second inverted U-shaped tubular support member, generally designated 30, defining two substantially parallel, vertically disposed third 18 and fourth 22 leg members and a substantially horizontal second handle member 24. At least one adjoining member 26 is affixed to each of first leg member 12 and third leg member 18 for connecting the first inverted U-shaped tubular support member 20 to such second inverted U-shaped tubular support member 30.

Further included is an illumination means, generally designated 40, disposed within a predetermined portion of at least one of the leg members, preferably in all of them, for providing light to increase visibility onto such walking path of such user. The illumination means 40 may be one of an incandescent bulb, a florescent bulb and a LED 28.

A power source, generally designated 50, is disposed within at least one of the first handle member 16 and such second handle member 24 and connected to the illumination means 40 for providing energy to such illumination means 40. The power source 50 may be one of at least one battery 32 a rechargeable battery pack. If the power source 50 is the rechargeable battery pack, then a connection port 34 can be provided for electrically connecting a charger 36 to such rechargeable battery pack.

Each of the leg members may include either of a wheel member 38 one of permanently and removably disposed on a lower distal end thereof capable of rotating substantially about 360°, or each of leg members may include a resilient rubber grip member 42 one of permanently and removably disposed on the lower distal end thereof.

However, in a presently preferred embodiment of the invention, each of the second 14 and fourth 22 leg members will have a resilient rubber grip member 42 disposed thereon and each of the first 12 and third 18 leg members will have a substantially hollow resilient rubber grip member 44 one of permanently and removably disposed thereon and include a flip down wheel member 46 disposed therein capable of rotating substantially about 360°.

Also, in the presently preferred embodiment, at least one of the first 16 and second 24 handle members will include a push button control 48 for at least one of extending and retracting the flip down wheel members 46 and applying a safety lock thereto locking them in place when the user is stopped.

The predetermined portion of each of the leg members having illumination means 40 disposed therein is made of a material that will allow light to pass through, such as acrylic, thus allowing the illumination means 40 to light substantially about 360° therethrough.

The power source 50 is, preferably, controlled by a push button control switch 52 disposed on at least one of first 16 and second 24 handle members. The push button control switch 52 can be set up to work as follows. If pushed once, it will illuminate the first 12 and third 18 leg members, when pushed again, it will illuminate the second 14 and fourth 22 leg members and finally, when pushed again, it will shut off illumination of all leg members.

At least one of either the first 16 or second 24 handle members may include a resilient rubber grip portion 54 disposed thereon for such user to hold onto when walking.

The illuminated convalescent walker 10 may further include a basket member 56 that attaches to the at least one adjoining member 26 for holding pre-selected objects.

Also, a length of each of the first 12, second 14, third 18 and fourth 22 leg members may be adjustable by means of a spring loaded push pin 58, as shown in FIG. 5. This spring loaded push pin 58 is also used in the embodiments where either of the resilient rubber grip members or the wheel members are removably attached to the leg members.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An illuminated convalescent walker for providing increased visibility onto a walking path of a user, said illuminated convalescent walker comprising:
(a) a first inverted U-shaped tubular support member defining two substantially parallel, vertically disposed first and second leg members and a substantially horizontal first handle member;
(b) a second inverted U-shaped tubular support member defining two substantially parallel, vertically disposed third and fourth leg members and a substantially horizontal second handle member;
(c) at least one adjoining member affixed to each of said first leg member and said third leg member for connecting said first inverted U-shaped tubular support member to said second inverted U-shaped tubular support member;
(d) an illumination means disposed within a predetermined portion of at least one of said leg members for providing light to increase visibility onto such walking path of such user; and
(e) a power source disposed within at least one of said first handle member and said second handle member and connected to said illumination means for providing energy to said illumination means.

2. An illuminated convalescent walker, according to claim 1, wherein each of said leg members includes a wheel member one of permanently and removably disposed on a lower distal end thereof, said wheel member capable of rotating substantially about 360°.

3. An illuminated convalescent walker, according to claim 1, wherein each of said leg members includes a resilient rubber grip member one of permanently and removably disposed on a lower distal end thereof.

4. An illuminated convalescent walker, according to claim 3, wherein said resilient rubber grip members disposed on said first and said third leg members are substantially hollow and include a flip down wheel member disposed therein, said flip down wheel members capable of rotating substantially about 360°.

5. An illuminated convalescent walker, according to claim 4, wherein at least one of said first and said second handle members includes a push button control for at least one of extending and retracting said flip down wheel members and applying a safety lock to said flip down wheel members disposed in said resilient rubber grip members disposed on said first and said third leg members.

6. An illuminated convalescent walker, according to claim 1, wherein each of said first and said third leg members includes a resilient rubber grip member one of permanently and removably disposed on a lower distal end thereof and each of said second and said fourth leg members includes a wheel member one of permanently and removably disposed on a lower distal end thereof, said wheel member capable of rotating substantially about 360°.

7. An illuminated convalescent walker, according to claim 6, wherein said resilient rubber grip members disposed on said first and said third leg members are substantially hollow and include a flip down wheel member disposed therein, said flip down wheel members capable of rotating substantially about 360°.

8. An illuminated convalescent walker, according to claim 7, wherein at least one of said first and said second handle members includes a push button control for at least one of extending and retracting said flip down wheel members and applying a safety lock to said flip down wheel members disposed in said resilient rubber grip members disposed on said first and said third leg members.

9. An illuminated convalescent walker, according to claim 1, wherein at least one of said first and second handle members includes a resilient rubber grip portion disposed thereon for such user to hold onto when walking.

10. An illuminated convalescent walker, according to claim 1, wherein said predetermined portion of said at least one of said leg members having said illumination means disposed therein is made of acrylic.

11. An illuminated convalescent walker, according to claim 10, wherein said illumination means is one of an incandescent bulb, a florescent bulb and a LED.

12. An illuminated convalescent walker, according to claim 11, wherein said illumination means lights substantially about 360° through said predetermined portion of said at least one of said leg members.

13. An illuminated convalescent walker, according to claim 12, wherein said illumination means is disposed in each of said leg members.

14. An illuminated convalescent walker, according to claim 13, wherein said power source is controlled by a push button control switch disposed on at least one of said first and second handle members.

15. An illuminated convalescent walker, according to claim 14, wherein said push button control switch is pushed once to illuminate said first and said third leg members, pushed again to illuminate said second and said fourth leg members and pushed again to shut off illumination of all leg members.

16. An illuminated convalescent walker, according to claim 1, wherein said power source is at least one battery.

17. An illuminated convalescent walker, according to claim 1, wherein said power source is a rechargeable battery pack.

18. An illuminated convalescent walker, according to claim 17, wherein said power source includes a connection port for electrically connecting a charger to said rechargeable battery pack.

19. An illuminated convalescent walker, according to claim 1, wherein said illuminated convalescent walker further includes a basket member engageable with said at least one adjoining member for holding pre-selected objects.

20. An illuminated convalescent walker, according to claim 1, wherein a length of each of said first, second, third and fourth legs are adjustable.
